(19) United States
(12) Patent Application Publication
(10) Pub. No.: US 2011/0305936 A1
(43) Pub. Date: Dec. 15, 2011

(54) Connecting structure of battery stacks

(76) Inventors: No-Hyun Kwag, Yongin-si (KR); Jeong-Deok Byun, Yongin-si (KR); Jung-Yeop Han, Yongin-si (KR); Kyung-Won Seo, Yongin-si (KR); Watson Doh, Yongin-si (KR); Jin-Hong An, Yongin-si (KR)

(21) Appl. No.: 12/929,099

(22) Filed: Dec. 30, 2010

(30) Foreign Application Priority Data
Jun. 9, 2010 (KR) 10-2010-0054462

(51) Int. Cl. H01M 2/20; H01R 25/00

(52) U.S. Cl. 429/121; 439/110

(57) ABSTRACT

A connecting structure of battery stacks includes an electricity collecting case with a plurality of battery stacks, each battery stack having a plurality of unit battery cells and power terminal portions, at least one bus bar with a plurality of fastening holes along a length direction thereof, the bus bar connecting the battery stacks via respective power terminal portions in the fastening holes, and an insulating layer on a surface of the bus bar.

### BACKGROUND

1. Field

Example embodiments relate to a connecting structure of battery stacks, and more particularly, to a connecting structure of battery stacks connected to one another through a bus bar.

2. Description of the Related Art

Recently, as mobile devices are widely used, studies on secondary batteries used as their power sources have been actively conducted. The secondary batteries, i.e., rechargeable batteries, may be divided into nickel-cadmium batteries, nickel-hydrogen batteries, nickel-zinc batteries, and lithium batteries.

The secondary battery may include a jelly-roll type electrode assembly sealed in an interior of, e.g., a prismatic or a cylindrical, case. For example, the electrode assembly may be formed by winding a positive electrode, a negative electrode, and a separator interposed therebetween.

A single secondary battery or a plurality thereof may be used according to application fields. For example, while a single battery may be used in a low-power product, e.g., a cellular phone, a plurality of batteries, i.e., a battery stack having unit batteries connected to one another, may be used in a high power product, e.g., a medium- or small-sized industrial machine. Electricity may be further collected by connecting a plurality of battery stacks to one another to provide a large-capacity and high-power structure of battery stacks.

When battery stacks are connected to each other, each of the battery stacks has a structure in which a plurality of unit batteries are installed in separate electricity collecting cases that are connected to one another. Further, the battery stacks are connected to one another through a separate bus bar. For example, an end portion of the bus bar may be connected to a power terminal portion provided to each of the electricity collecting cases through a bolt or the like.

### SUMMARY

Embodiments are directed to a connecting structure of battery stacks, which substantially overcome one or more of the problems due to the limitations and disadvantages of the related art.

It is a feature of an embodiment to provide a connecting structure of battery stacks having an insulating layer on a surface of a bus bar, thereby preventing a short circuit due to a connection failure of the battery stacks or due to an unnecessary contact with an external object.

It is another feature of an embodiment to provide a connecting structure of battery stacks having an insulating layer on a surface of a bus bar, thereby preventing heat dissipation from the bus bar toward adjacent elements.

It is still another feature of an embodiment to provide a connecting structure of battery stacks having an insulating layer on a bus bar, thereby providing effective insulating efficiency.

At least one of the above and other features and advantages may be realized by providing a connecting structure of battery stacks, including a plurality of battery stacks, each battery stack having a plurality of unit battery cells in an electricity collecting case and power terminal portions, at least one bus bar with a plurality of fastening holes along a length direction thereof, the bus bar connecting the battery stacks via respective power terminal portions in the fastening holes, and an insulating layer on a surface of the bus bar.

Each power terminal portion may include a connecting panel contacting an inner surface of the bus bar, a fastening member connected to the connecting panel, the fastening member protruding from the battery stack and passing through a fastening hole of the bus bar, and a fixing member connected to an end portion of the fastening member, the fixing member being separate from the fastening member, and the bus bar being between the fixing member and the connecting panel.

The end portion of the fastening member may be a fastening projection having screw threads formed thereon. The fastening member may be a bolt, and the fixing member may be a nut.

The connecting panel may include a contact plate contacting the inner surface of the bus bar.

The insulating layer may be on an outer surface of the bus bar, the outer surface facing the fixing member.

The insulating layer may be only on a first section of the outer surface, the first section of the outer surface excluding a section of the outer surface contacting the fixing member.

The insulating layer may be on an inner surface of the bus bar, the inner surface of the bus bar facing the electricity collecting case.

The insulating layer may be on an inner surface of the bus bar, the inner surface of the bus bar facing the electricity collecting case.

The insulating layer may be on an outer surface of the bus bar, the outer surface being opposite the inner surface.

The insulating layer may be only on the inner surface of the bus bar.

The insulating layer may be on a first section of the inner surface, the first section of the inner surface excluding a portion of the inner surface contacting the power terminal portion.

The insulating layer may be on all exposed surfaces of the bus bar.

The insulating layer may be on an inner circumferential surface of each of the fastening holes of the bus bar.

The insulating layer may include at least one of polyvinyl chloride (PVC), polyester, polyamide, and urethane.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1A illustrates a partially enlarged perspective view of bus bars connected to power terminals of a battery stack according to example embodiments.

FIG. 1B illustrates an enlarged perspective view of a bus bar with an insulating layer according to example embodiments.

FIG. 2 illustrates a schematic plan view of power terminal portions of respective battery stacks connected through the bus bars of FIG. 1B.

FIG. 3 illustrates a partially enlarged cross-sectional view of a connecting structure between a bus bar and a power terminal portion according to example embodiments, when the insulating layer is formed on inner and outer surfaces of the bus bar.

FIG. 4 illustrates a partially enlarged cross-sectional view of a connecting structure according to other example embodiments, when the insulating layer is only on an inner surface of the bus bar.

FIG. 5 illustrates a partially enlarged cross-sectional view of a connecting structure according to other example embodiments, when the insulating layer is only on an outer surface of the bus bar.

FIG. 6 illustrates a partially enlarged cross-sectional view of a connecting structure according to other example embodiments, when the insulating layer is on an inner circumferential surface of a fastening hole of a bus bar.

### DETAILED DESCRIPTION

Korean Patent Application No. 10-2010-0054462, filed on Jun. 9, 2010, in the Korean Intellectual Property Office, and entitled: “Connecting Structure of Battery Stack” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration. It will also be understood that when an element (or layer) is referred to as being “on” another element, it can be directly on the other element, or intervening elements may also be present. In addition, it will also be understood that when an element is referred to as being “between” two elements, it can be the only element between the two elements, or one or more intervening elements may also be present. Also, when an element is referred to as being “connected to” another element, it can be directly connected to the other element or one or more intervening elements may also be present. Hereinafter, like reference numerals refer to like elements throughout.

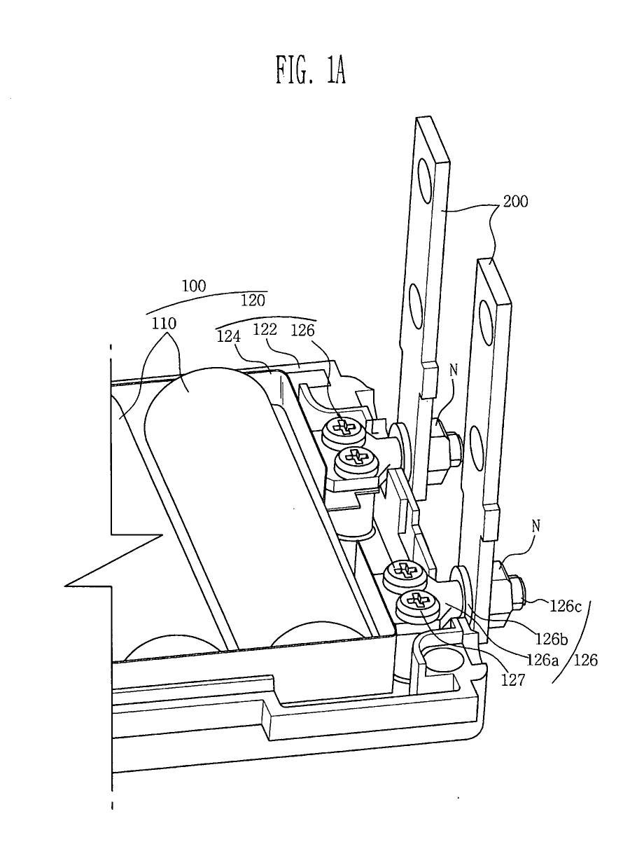

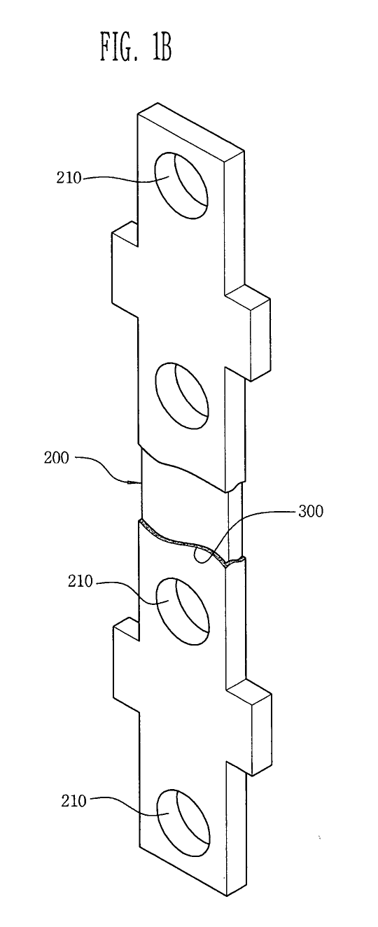

A connecting structure of battery stacks according to an embodiment will be described hereinafter with reference to FIGS. 1A-3. Referring to FIGS. 1A-3, a battery stack 100 may include a plurality of unit battery cells 110 in an electricity collecting case 120, bus bars 200 connected to power terminal portions 126, and insulating layers 300 on the bus bars 200.

As illustrated in FIG. 1A, each battery stack 100 collects initial electricity by connecting unit batteries, i.e., unit battery cells 110, directly to one another. Therefore, the battery stack 100 may include a plurality of unit battery cells 110 in the electricity collecting case 120.

The electricity collecting case 120 may accommodate the unit battery cells 110 installed therein, and may provide a medium for initial electricity collection between the unit battery cells 110. The electricity collecting case 120 may include an installation body 122, an electricity collecting plate 124, and the power terminal portions 126.

The installation body 122 serves as a frame in which the components of the electricity collecting case 120 are installed. An installation space having the unit battery cells 110 installed therein is defined in an interior of the installation body 122, and the electricity collecting plate 124 for electrical connection of the unit battery cells 110 may be formed on inner walls of the installation body 122, e.g., to surround the installation space.

For example, ten battery unit cells 110 may be installed in the installation body 122. It will be apparent that the installation body 122 may be manufactured by changing the capacity of the unit battery cells 110 depending on a desired electricity collecting efficiency.

The electricity collecting plate 124 may be partitioned for each electrode, so that the same electrodes of the unit battery cells 110 may be connected to one another. The electricity collecting plate 124 may be made a material having a high electricity collecting efficiency, e.g., nickel (Ni). However, the material of the electricity collecting plate 124 is not limited thereto, and may be variously selected and applied.

The power terminal portion 126 may be provided at one side of the electricity collecting plate 124, and serves as an output portion of the battery stack 100. That is, the power terminal portion 126 may extend from an outer wall of the electricity collecting plate 124 inside the installation body 122 toward an exterior of the installation body 122. Therefore, electricity collected through the electricity collecting plate 124 may be output through the power terminal portion 126 outside the electricity collecting case 120.

As further illustrated in FIG. 1A, the power terminal portion 126 may include a, e.g., plate-shaped, connecting panel 126a, a contact plate 126b, and a fastening projection 126c. The connecting panel 126a may contact the outer wall of the electricity collecting plate 124, and may extend to the exterior of the installation body 122. The contact plate 126b may be attached, e.g., integral with, the connecting panel 126a, and may be positioned outside the electricity collecting case 120. The fastening projection 126c may connect the bus bar 200 to, e.g., a center of an outer surface of, the contact plate 126b and may protrude outward from the installation body 122. Screw threads may be formed at an end portion of the fastening projection 126c, so that the fastening projection 126c may be connected to a separate nut member N therethrough. As further illustrated in FIG. 1A, the power terminal portion 126 may be installed so that the connecting panel 126a is fixed on the installation body 122 through separate fixing bolts 127.

The unit battery cells 110 are secondary batteries in the electricity collecting case 120, and may have, e.g., a cylindrical or prismatic structure. The unit battery cells 110 may be arranged in the installation space of the installation body 122, such that electrodes, i.e., both electrodes of each, of the unit battery cells 110, contact the electricity collecting plate 124.

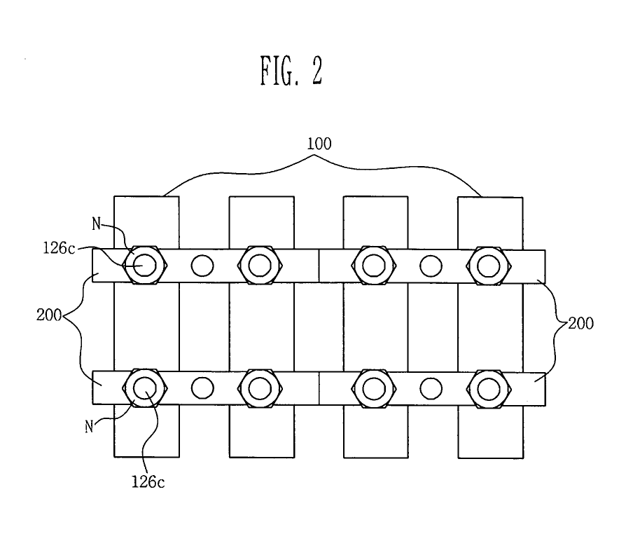

As illustrated in FIG. 2, a plurality of battery stacks 100 configured as describe above may be connected to one another, thereby performing the electricity collection of each of the battery stacks 100. As further illustrated in FIG. 2, the connection among the battery stacks 100 is made through the bus bars 200.

In detail, the bus bars 200 perform electricity collection by electrically connecting the battery stacks 100 to one another as described above. The bus bars 200 may conduct large amounts of electricity and require simple maintenance and repair as compared to other connection mechanisms, e.g., general electric cables.

As illustrated in FIG. 1B, the bus bar 200 may have a planar shape, e.g., a simple metal bar, and may be made, e.g., of a copper (Cu) or aluminum (Al) material. The bus bar 200 may have any suitable length according to a number of battery stacks 100 to be connected. The allowable current density applied to the bus bar 200 is about 1.5 A/cm² to about 2 A/cm². It will be apparent that the allowable current density may be changed according to the entire electricity collection and output capacity.

As further illustrated in FIG. 1B, the bus bar 200 may include fastening holes 210 therethrough. The fastening holes 210 may be formed along a length direction of the bus bar 200 with a predetermined interval therebetween. The bus bar 200 may be fastened to the power terminal portions 126 of each of the battery stacks 100 through the fastening holes 210 (FIGS. 1A and 2). The number of the fastening holes 210 may be adjusted according to the number of battery stacks 100 to be connected.

For example, as illustrated in FIG. 3, a primary connection is performed as the fastening projection 126c of each of the power terminal portions 126 in a corresponding battery stack 100 passes through the fastening hole 210 of the bus bar 200. A fixing connection is performed as a separate nut member N is connected to the screw threads S of the fastening projection 126c that passes through the fastening hole 210. In this state, if the nut member N is tightened, an inner surface 201 of the bus bar 200 may contact, e.g., directly contact, the contact plate 126b of the power terminal portion 126, so that an electrical connection is made between the bus bar 200 and the power terminal portion 126.

According to example embodiments, a separate insulating layer 300 may be formed on a surface of the bus bar 200. The insulating layer 300 provides an insulating function to the bus bar 200, so as to prevent a short circuit, e.g., due to an external contact and the like. A detailed description of the insulating layer 300 will be provided with reference to FIGS. 1B and 3.

As illustrated in FIGS. 1B and 3, the insulating layer 300 may be formed on a surface of the bus bar 200 using an insulating material. For example, the insulating material used for the insulating layer 300 may be polyvinyl chloride (PVC). In another example, the insulating material may be a polymer, e.g., at least one of polyester, polyamide, and polyurethane. In yet another example, the insulating material may be any suitable material having insulating and heat radiation prevention functions.

As illustrated in FIG. 1B, the insulating layer 300 may cover the bus bar 200, e.g., cover an entire surface of the bus bar 200. For example, the insulating layer 300 may be formed in a shape of a resin to be coated on the surface of the bus bar 200. In another example, the insulating layer 300 may be formed in a shape of a separate tube, so the bus bar 200 may be inserted thereinto. In yet another example, the insulating layer 300 may be variously formed, e.g., using a dipping method and the like.

As illustrated in FIGS. 1B and 3, the insulating layer 300 may be formed on, e.g., directly on, the bus bar 200, e.g., the insulating layer 300 may cover inner and outer surfaces 201 and 201 of the bus bar 200 (FIG. 3). For example, the insulating layer 300 may cover all exposed surfaces of the bus bar 200, except a contact section “A” illustrated in FIG. 3. That is, the contact section “A” includes a surface contact between the contact plate 126b of the power terminal portion 126 and the inner surface 201 of the bus bar 200, so that an electrical connection may be smoothly made between the bus bar 200 and the contact plate 126b. Accordingly, the insulating layer 300 may cover exposed surfaces of the bus bar 200 that surround the contact section “A” and the fastening projection 126c. For example, a thickness of the insulating layer 300, i.e., as measured from the inner surface 201 of the bus bar 200, may be smaller than a thickness of the contact plate 126b, so a space may be defined between the insulating layer 300 on the inner surface 201 of the bus bar 200 and the electricity collecting case 120.

As the insulating layer 300 is formed to cover the entire inner and outer surfaces 201 and 220 of the bus bar 200, with the exception of the contact section “A” and the fastening projection 126c, short circuit may be prevented even if an external object contacts the inner and/or outer surfaces 201 and 202 of the bus bar 200 when the battery stacks 100 are connected to one another. Further, although heat is generated from the bus bar 200 during the electricity collecting process, the insulating layer 300 may prevent heat dissipation from the bus bar 200 toward peripheral devices, e.g., adjacent electrical devices.

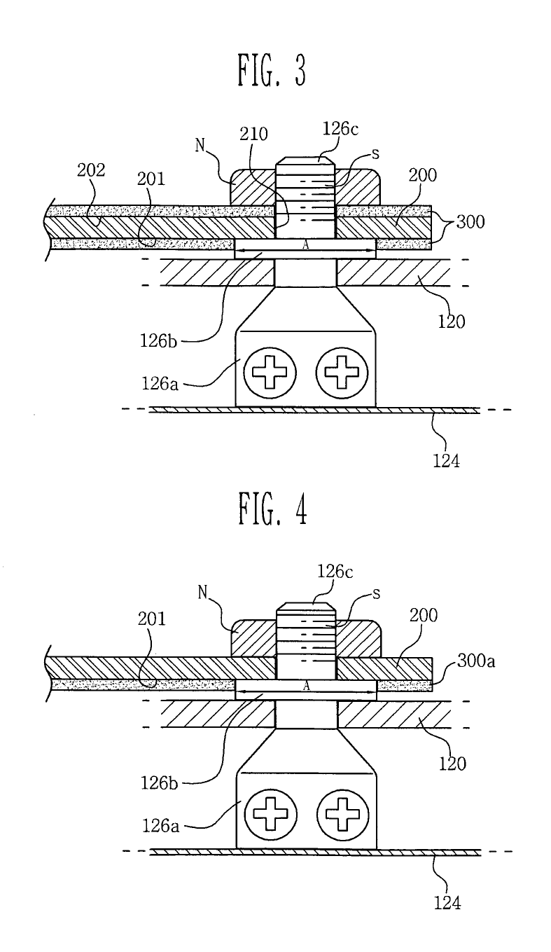

In another embodiment, as illustrated in FIG. 4, an insulating layer 300a may be formed only on the inner surface 201 of the bus bar 200. In this case, the insulating layer 300a may be formed on the entire inner surface 201, except in the contact section “A”. For example, the insulating layer 300a may be on the inner surface 201 to contact and surround the contact plate 126b. That is, when the bus bar 200 is not likely to contact an external object, the insulating layer 300 may be formed only on the inner surface 201 of the bus bar 200. Thus, it may be possible to prevent a short circuit, e.g., due to electrode failure or the like in the process of connecting/separating the battery stack 100 to/from the bus bar 200.

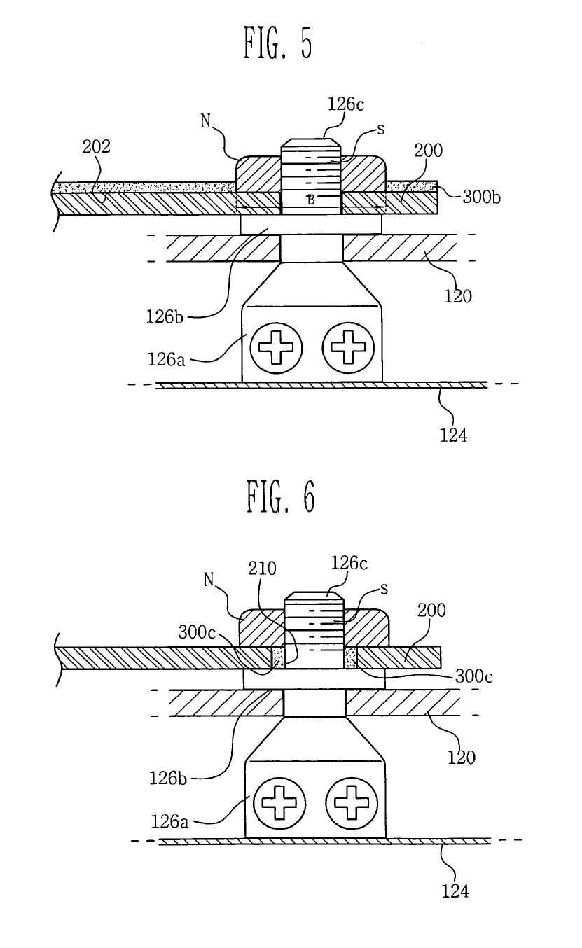

In yet another embodiment, as illustrated in FIG. 5, an insulating layer 300b may be formed only on the outer surface 202 of the bus bar 200. In this case, the insulating layer 300b may be formed on the entire outer surface 202, except in a contact section “B,” i.e., a region including the fastening holes 210. For example, when the bus bar 200 is likely to contact an external object, rather than have a failed connection with the battery stack 100, the insulating layer 300b may be formed only on the outer surface 202 of the bus bar 200.

It is noted that the contact section “B” further includes the electrical connection between the bus bar 200 and the power terminal portion 126 via the fastening projection 126c and the nut member N thereon. Therefore, when the insulating layer 300b is formed on the outer surface 202 of the bus bar 200, as described above, the insulating layer 300b may be formed in a section of the outer surface 202 other than the contact section “B.” For example, the insulating layer 300b may be on the outer surface 202 to contact and surround the nut member N. Thus, even when a contact failure between the contact plate 126b of the power terminal portion 126 and the inner surface 201 of the bus bar 200 occurs, a contact point may be maintained by a contact between the outer surface 202 of the bus bar 200 and the nut member N.

In still another embodiment, as illustrated in FIG. 6, an insulating layer 300c may be formed, e.g., only, on an inner circumferential surface of the fastening holes 210 of the bus bar 200. That is, the insulating layer 300c may fill a gap between the fastening projection 126c and inner sidewalls of the fastening holes 210 of the bus bar 200. In this case, it may be possible to prevent a short circuit between the inner circumferential surface of the fastening hole 210 and the fastening projection 126c, when the fastening projection 126c is inserted into the fastening hole 210 during the process of connecting the battery stack 100 to the bus bar 200, e.g., when the electrode of the power terminal portion 126 is changed by accident.

It is noted that the insulating layer 300c may also be formed on the inner and outer surfaces 201 and 202 of the bus bar 200. In this instance, the insulating layer 300c is not formed in the contact section “A” between the bus bar 200 and the contact plate 126b or in the contact section “B” between the bus bar 200 and the nut member N. Therefore, electricity conduction may be smoothly made in the normal connection between the bus bar 200 and the power terminal portion 126.

As described above, according to example embodiments, a separate insulating layer may be formed on a surface of a bus bar that connects battery stacks to one another. Therefore, it may be possible to prevent a short circuit, e.g., caused by an unnecessary contact with an external conducting object, failed or erroneous connection of the electrode of the power terminal portion of the battery stack, or the like. Also, the formation position of the insulating layer may be variously modified, e.g., the insulation layer may be locally formed on one or more of the inner/outer surfaces of the bus bar and the inner circumferential surface of a fastening hole, so that effective insulating efficiency may be obtained. Further, it may be possible to prevent heat generated from the bus bar during the electricity collecting process from being dissipated to the exterior, thereby further preventing degradation of performance of peripheral devices due to the heat dissipation.

In contrast, an entire surface of a conventional bus bar, i.e., a bus bar without an insulating layer, may be exposed to the exterior thereof, thereby causing a short circuit between the power terminal portion and the bus bar, e.g., when the bus bar contacts a separate external conductor during connection of respective battery stacks or during a subsequent electricity collection. Also, as the bus bar generates heat in the process of collecting electricity, devices adjacent to the bus bar, e.g., wiring devices, may be densely aggregated around the bus bar and poorly affected by the generated heat in the conventional bus bar.

Various features of the present invention described above may be modified and combined by those skilled in the art. However, the modification and combination provide a connecting structure of battery stacks through a bus bar, in which a separate insulating layer is formed on the surface of the bus bar. Therefore, when the modification and combination are related to the configuration and object in which it is possible to prevent a short circuit that may be caused in the installation and electricity collection process, they may be included in the protection scope of the present invention.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A connecting structure for use with a plurality of battery stacks, each battery stack having a plurality of unit battery cells in an electricity collecting case and power terminal portions, the connecting structure comprising:
at least one bus bar with a plurality of fastening holes along a length direction thereof, the bus bar connecting the battery stacks via respective power terminal portions in the fastening holes; and
an insulating layer on a surface of the bus bar.

2. The connecting structure as claimed in claim 1, wherein each power terminal portion includes:
a connecting panel contacting an inner surface of the bus bar,
a fastening member connected to the connecting panel, the fastening member protruding from the battery stack and passing through a fastening hole of the bus bar, and
a fixing member connected to an end portion of the fastening member, the fixing member being separate from the fastening member, and the bus bar being between the fixing member and the connecting panel.

3. The connecting structure as claimed in claim 2, wherein the end portion of the fastening member is a fastening projection having screw threads thereon.

4. The connecting structure as claimed in claim 3, wherein the fastening member is a bolt, and the fixing member is a nut.

5. The connecting structure as claimed in claim 2, wherein the connecting panel includes a contact plate contacting the inner surface of the bus bar.

6. The connecting structure as claimed in claim 5, wherein the insulating layer is on an outer surface of the bus bar, the outer surface facing the fixing member.

7. The connecting structure as claimed in claim 6, wherein the insulating layer is only on a first section of the outer surface, the first section of the outer surface excluding a section of the outer surface contacting the fixing member.

8. The connecting structure as claimed in claim 6, wherein the insulating layer is on an inner surface of the bus bar, the inner surface of the bus bar facing the electricity collecting case.

9. The connecting structure as claimed in claim 1, wherein the insulating layer is on an inner surface of the bus bar, the inner surface of the bus bar facing the electricity collecting case.

10. The connecting structure as claimed in claim 9, wherein the insulating layer is on an outer surface of the bus bar, the outer surface being opposite the inner surface.

11. The connecting structure as claimed in claim 9, wherein the insulating layer is only on the inner surface of the bus bar.

12. The connecting structure as claimed in claim 9, wherein the insulating layer is on a first section of the inner surface, the first section of the inner surface excluding a portion of the inner surface contacting the power terminal portion.

13. The connecting structure as claimed in claim 1, wherein the insulating layer is on all exposed surfaces of the bus bar.

14. The connecting structure as claimed in claim 1, wherein the insulating layer is on an inner circumferential surface of each of the fastening holes of the bus bar.

15. The connecting structure as claimed in claim 1, wherein the insulating layer includes at least one of polyvinyl chloride (PVC), polyester, polyamide, and urethane.

16. A battery structure, comprising:
a plurality of battery stacks, each battery stack having a plurality of unit battery cells in an electricity collecting case and power terminal portions;
at least one bus bar with a plurality of fastening holes along a length direction thereof, the bus bar connecting the battery stacks via respective power terminal portions in the fastening holes; and
an insulating layer on a surface of the bus bar.
